(19) United States
(12) Patent Application Publication
(10) Pub. No.: US 2024/0142701 A1
(43) Pub. Date: May 2, 2024

(54) Optical Waveguide Structure and Method for Manufacturing Same

(71) Applicant: Shanghai Huali Microelectronics Corporation, Shanghai (CN)

(72) Inventors: Kai Guo, Shanghai (CN); Keqiang He, Shanghai (CN); Lei Zhang, Shanghai (CN); Haoyu Chen, Shanghai (CN)

(73) Assignee: Shanghai Huali Microelectronics Corporation, Shanghai (CN)

(21) Appl. No.: 18/199,678

(22) Filed: May 19, 2023

(30) Foreign Application Priority Data
Oct. 28, 2022 (CN) 202211331528.8

(51) Int. Cl. G02B 6/124; G02B 6/13

(52) U.S. Cl. CPC G02B 6/124; G02B 6/13; G02B 2006/12061

(57) ABSTRACT

The present application discloses an optical waveguide structure, comprising: a lower cladding layer composed of a first dielectric layer; and a core layer which is composed of a patterned structure of a second material layer and presents a strip structure. A first trench is formed in a top region of the core layer. An upper cladding layer fully fills the first trench, extends to a top surface of the core layer outside the first trench, and coats side faces of the core layer in a width direction of the core layer. A refractive index of the second material layer is greater than a refractive index of the first dielectric layer, and the refractive index of the second material layer is greater than a refractive index of the upper cladding layer. The present application also provides a method for manufacturing an optical waveguide structure.

### CROSS-REFERENCE TO RELATED APPLICATIONS

This application claims priority to Chinese Patent Application No. 202211331528.8, filed on Oct. 28, 2022, the disclosure of which is incorporated herein by reference in its entirety.

### TECHNICAL FIELD

The present application relates to the field of manufacturing semiconductor integrated circuits, in particular to an optical waveguide structure. The present application also relates to a method for manufacturing an optical waveguide structure.

### BACKGROUND

In silicon optical products, optical waveguides play an important role as dielectric devices which guide the propagation of optical waves within devices. However, such devices may cause significant optical losses due to scattering, absorption, and radiation losses.

FIG. 1 is a schematic diagram of an existing optical waveguide structure. The existing optical waveguide structure is formed on a semiconductor on insulation (SOI) substrate.

The SOI substrate includes a bottom semiconductor substrate 101, a dielectric buried layer 102, and a top semiconductor layer 103.

Typically, the material of the bottom semiconductor substrate 101 is silicon; the material of the dielectric buried layer 102 is an oxide layer; and the material of the top semiconductor layer 103 is silicon.

The SOI substrate includes both a formation region 104 of the optical waveguide structure and a formation region 105 of a grating coupler.

The formation region 104 of the optical waveguide structure includes a plurality of core layers formed by patterning the top semiconductor layer 103, including a strip core layer 103a and a ridge core layer 103b.

The dielectric buried layer 102 serves as a lower cladding layer.

FIG. 1 also shows that a hard mask layer 106 composed of an oxide layer 1061 and a silicon nitride layer 1062 is formed on the surfaces of the strip core layer 103a and the ridge core layer 103b.

An upper cladding layer can directly adopt air and a dielectric layer such as an additional oxide layer which coats the surface of the core layer. Since a refractive index of the core layer composed of a silicon material is greater than a refractive index of the lower cladding layer composed of an oxide layer and also greater than a refractive index of the upper cladding layer, light incident into the core layer can undergo total reflection and be propagated. Therefore, the optical waveguide is composed of the core layer and both upper and lower cladding layers.

A strip structure 103c formed by patterning the top semiconductor layer 103 is formed in the formation region 105 of the grating coupler. A plurality of trenches 104 formed by patterning the top semiconductor layer 103 and a plurality of grating lines each located between the trenches 104 and composed of the top semiconductor layer 103 are formed on the strip structure 103c. On the strip structure 103c of the grating coupler, the plurality of trenches 104 and the grating lines are arranged alternately to form the grating coupler. The grating coupler can diffract and interfere with light propagated in the optical waveguide structure, so as to couple the light in different optical waveguide structures or between the optical waveguide structure and an external fiber.

The existing optical waveguide structure shown in FIG. 1 has the following defects:
1. The existing optical waveguide devices mainly include a strip waveguide and a ridge waveguide, both increasing optical losses due to rough sidewalls thereof.
2. Moreover, due to the inability to restrict light within a specific range, a restriction imposed by an optical waveguide on light is weak, thereby causing additional optical losses.

### BRIEF SUMMARY

According to some embodiments in this application, an optical waveguide structure includes:
a lower cladding layer composed of a first dielectric layer; and
a core layer composed of a patterned structure of a second material layer.

The core layer presents a strip structure.

The strip structure of the core layer has a first side face and a second side face on two sides of a width direction thereof, and the first side face and the second side face both extend along a length direction of the strip structure of the core layer.

A first trench is formed in a top region of the core layer, the first trench has a third side face and a fourth side face, the third side face and the fourth side face are located between the first side face and the second side face, and the third side face and the fourth side face both extend along the length direction of the strip structure of the core layer.

An upper cladding layer fully fills the first trench, extends to a top surface of the core layer outside the first trench, and coats the first side face and the second side face.

A refractive index of the second material layer is greater than a refractive index of the first dielectric layer, and the refractive index of the second material layer is greater than a refractive index of the upper cladding layer.

In some cases, the optical waveguide structure is formed on an SOI substrate.

The SOI substrate includes a bottom semiconductor substrate, a dielectric buried layer, and a top semiconductor layer.

The first dielectric layer is composed of the dielectric buried layer.

The second material layer is composed of the top semiconductor layer.

In some cases, the material of the bottom semiconductor substrate includes silicon.

The material of the dielectric buried layer includes an oxide layer.

The material of the top semiconductor layer includes silicon.

In some cases, the material of the upper cladding layer includes an oxide layer.

In some cases, a plurality of core layers are formed on the SOI substrate, a region between the core layers is a second trench, and the upper cladding layer fully fills the second trench.

In some cases, a grating coupler is formed on the SOI substrate, and the grating coupler is composed of the patterned structure of the second material layer and includes a plurality of third trenches formed by etching the second material layer and a plurality of grating lines each located between the third trenches and composed of the second material layer.

In some cases, a process structure of the first trench is the same as that of the third trench.

In some cases, the first trench is located in a middle region of the core layer in the width direction.

In order to solve the above technical problem, the method for manufacturing an optical waveguide structure provided by the present application includes the following steps:
step 1, providing a second material layer with a first dielectric layer formed at the bottom thereof, wherein the first dielectric layer serves as a lower cladding layer of the optical waveguide structure; and forming a hard mask layer on the surface of the second material layer, wherein a refractive index of the second material layer is greater than a refractive index of the first dielectric layer;
step 2, performing first patterned etching, including:
defining a formation region of a core layer by means of photolithography; and
sequentially etching the hard mask layer and the second material layer to form the core layer composed of the etched second material layer, wherein a top surface of the core layer is covered with the hard mask layer, the hard mask layer and the second material layer outside the core layer are both removed, the core layer presents a strip structure, the strip structure of the core layer has a first side face and a second side face on two sides of a width direction thereof, and the first side face and the second side face both extend along a length direction of the strip structure of the core layer;
step 3, performing second patterned etching, including:
defining a formation region of a first trench by means of photolithography, wherein the formation region of the first trench is located in a top region of the core layer; and
sequentially etching the hard mask layer and the second material layer to form the first trench, wherein the first trench has a third side face and a fourth side face, the third side face and the fourth side face are located between the first side face and the second side face, and the third side face and the fourth side face both extend along the length direction of the strip structure of the core layer; and
step 4, removing the hard mask layer, and forming an upper cladding layer, wherein the upper cladding layer fully fills the first trench, extends to the top surface of the core layer outside the first trench, and coats the first side face and the second side face.

In some cases, the first dielectric layer and the second material layer are provided by an SOI substrate in step 1.

The SOI substrate includes a bottom semiconductor substrate, a dielectric buried layer, and a top semiconductor layer.

The first dielectric layer is composed of the dielectric buried layer.

The second material layer is composed of the top semiconductor layer.

In some cases, the material of the bottom semiconductor substrate includes silicon.

The material of the dielectric buried layer includes an oxide layer.

The material of the top semiconductor layer includes silicon.

In some cases, the material of the upper cladding layer includes an oxide layer.

In some cases, the hard mask layer includes a first hard mask sublayer composed of an oxide layer and a second hard mask sublayer composed of silicon nitride.

In some cases, step 4 includes the following substeps:
forming a third oxide layer, wherein the third oxide layer fully fills the first trench, extends to a surface outside the first trench, and fully fills an external region of the core layer; and
performing a chemical mechanical polishing process to remove the third oxide layer on a top surface of the second hard mask sublayer and remove the second hard mask sublayer, such that the remained third oxide layer and the first hard mask sublayer jointly form the upper cladding layer.

In some cases, a plurality of core layers are formed on the SOI substrate, a region between the core layers is a second trench, and the upper cladding layer fully fills the second trench.

In some cases, a grating coupler composed of a patterned structure of the second material layer is formed on the SOI substrate, and a formation process of the grating coupler is integrated with that of the optical waveguide structure, including:
at the same when the first patterned etching is performed in step 2, defining a formation region of the grating coupler; and
at the same when the second patterned etching is performed in step 3, etching the second material layer in the formation region of the grating coupler to form a plurality of third trenches, wherein a grating line is composed of the second material layer between the third trenches.

In some cases, the first trench is located in a middle region of the core layer in the width direction.

In the optical waveguide structure of the present application, the first trench disposed in the top region of the core layer is added based on the strip structure of the core layer. Due to high and low refractive index differences, based on the feature of discontinuity of an electric field at an interface with a high refractive index difference, light can be restricted to the first trench after addition of the first trench, thereby enhancing a restriction imposed by an optical waveguide on light and reducing optical losses.

In addition, the first trench of the present application and the third trench of the grating coupler can be formed integrally, without addition of an additional mask layer. Therefore, compared to an existing optical waveguide of a strip structure, the present application does not increase the process costs. Compared to an existing ridge optical waveguide, the present application does not require cumbersome steps to achieve etching processes of different depths, so the present application can further reduce the process costs.

### BRIEF DESCRIPTION OF THE DRAWINGS

The present application will be further described in detail below with reference to the drawings and specific implementations:

FIG. 1 is a schematic diagram of an existing optical waveguide structure.

FIG. 2 is a schematic diagram of an optical waveguide structure according to an embodiment of the present application.

FIGS. 3A-3D are schematic diagrams of device structures in steps of a method for manufacturing an optical waveguide structure according to an embodiment of the present application.

### DETAILED DESCRIPTION OF THE DISCLOSURE

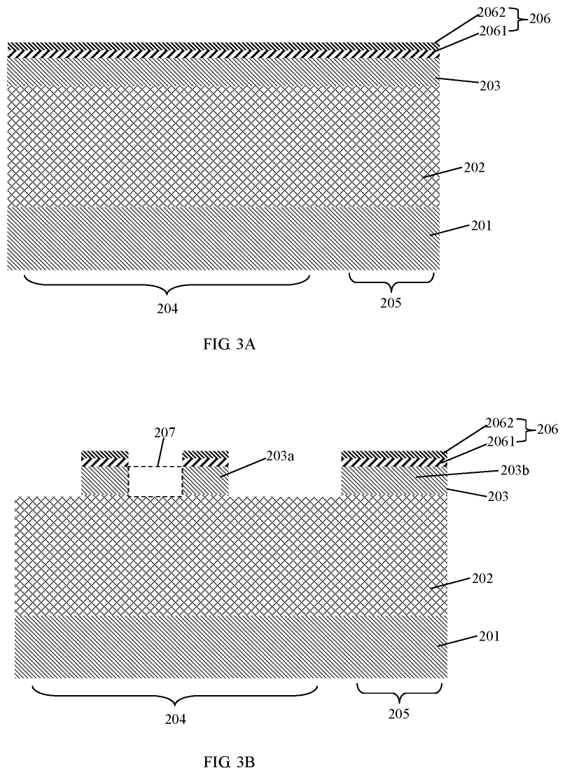

FIG. 2 is a schematic diagram of an optical waveguide structure according to an embodiment of the present application. The optical waveguide structure of this embodiment of the present application includes:
a lower cladding layer composed of a first dielectric layer 202; and
a core layer 203a composed of a patterned structure of a second material layer 203.

In this embodiment of the present application, the optical waveguide structure is formed on an SOI substrate.

The SOI substrate includes a bottom semiconductor substrate 201, a dielectric buried layer, and a top semiconductor layer.

The first dielectric layer 202 is composed of the dielectric buried layer.

The second material layer 203 is composed of the top semiconductor layer.

In some embodiments, the material of the bottom semiconductor substrate 201 includes silicon.

The material of the dielectric buried layer includes an oxide layer.

The material of the top semiconductor layer includes silicon.

The core layer 203a presents a strip structure.

The strip structure of the core layer 203a has a first side face and a second side face on two sides of a width direction thereof, and the first side face and the second side face both extend along a length direction of the strip structure of the core layer 203a.

A first trench 208 is formed in a top region of the core layer 203a, the first trench 208 has a third side face and a fourth side face, the third side face and the fourth side face are located between the first side face and the second side face, and the third side face and the fourth side face both extend along the length direction of the strip structure of the core layer 203a.

The first trench 208 is located in a middle region of the core layer 203a in the width direction.

An upper cladding layer 211 fully fills the first trench 208, extends to a top surface of the core layer 203a outside the first trench 208, and coats the first side face and the second side face.

A refractive index of the second material layer 203 is greater than a refractive index of the first dielectric layer 202, and the refractive index of the second material layer 203 is greater than a refractive index of the upper cladding layer 211.

In this embodiment of the present application, the material of the upper cladding layer 211 includes an oxide layer.

A plurality of core layers 203a are formed on the SOI substrate, a region between the core layers 203a is a second trench 207, and the upper cladding layer 211 fully fills the second trench 207.

The upper cladding layer 211 is composed of a third oxide layer 210 and a first hard mask sublayer 2061, wherein the third oxide layer 210 fills the first trench 208 and the second trench 207. The first hard mask sublayer 2061 covers the top surface of the core layer 203a outside the first trench 208.

A grating coupler is also formed on the SOI substrate. The SOI substrate includes both a formation region 204 of the optical waveguide structure and a formation region 205 of the grating coupler.

The grating coupler is composed of the patterned structure of the second material layer 203 and includes a plurality of third trenches 209 formed by etching the second material layer 203 and a plurality of grating lines each located between the third trenches 209 and composed of the second material layer 203. On a strip structure 203b of the grating coupler, the plurality of third trenches 209 and the grating lines are arranged alternately to form the grating coupler. The grating coupler can diffract and interfere with light propagated in the optical waveguide structure, so as to couple the light in different optical waveguide structures or between the optical waveguide structure and an external fiber.

A process structure of the first trench 208 is the same as that of the third trench 209, both formed simultaneously by the same etching process with the same width and the same depth.

In the optical waveguide structure of this embodiment of the present application, the first trench 208 disposed in the top region of the core layer 203a is added based on the strip structure of the core layer 203a. Due to high and low refractive index differences, based on the feature of discontinuity of an electric field at an interface with a high refractive index difference, light can be restricted to the first trench 208 after addition of the first trench 208, thereby enhancing a restriction imposed by an optical waveguide on light and reducing optical losses.

In addition, the first trench 208 of this embodiment of the present application and the third trench 209 of the grating coupler can be formed integrally, without addition of an additional mask layer. Therefore, compared to an existing optical waveguide of a strip structure, this embodiment of the present application does not increase the process costs. Compared to an existing ridge optical waveguide, this embodiment of the present application does not require cumbersome steps to achieve etching processes of different depths, so this embodiment of the present application can further reduce the process costs.

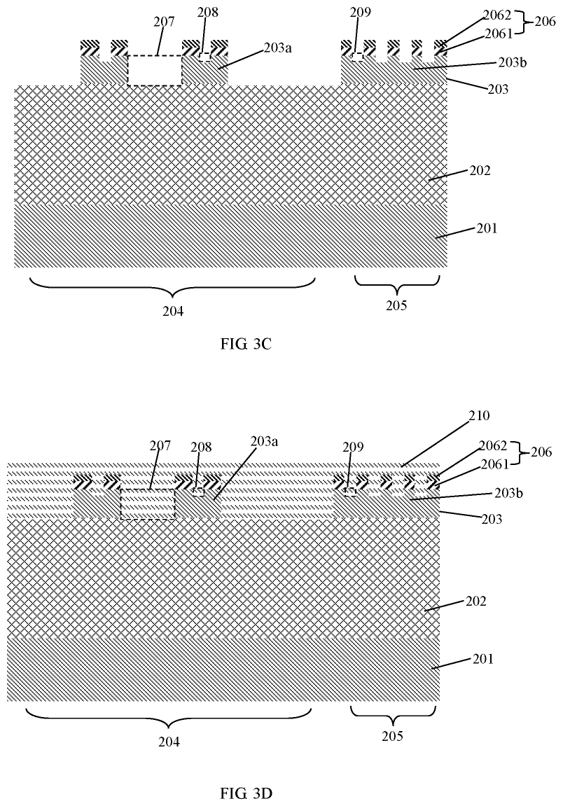

FIGS. 3A-3D are schematic diagrams of device structures in steps of a method for manufacturing an optical waveguide structure according to an embodiment of the present application. The method for manufacturing an optical waveguide structure of this embodiment of the present application includes the following steps:

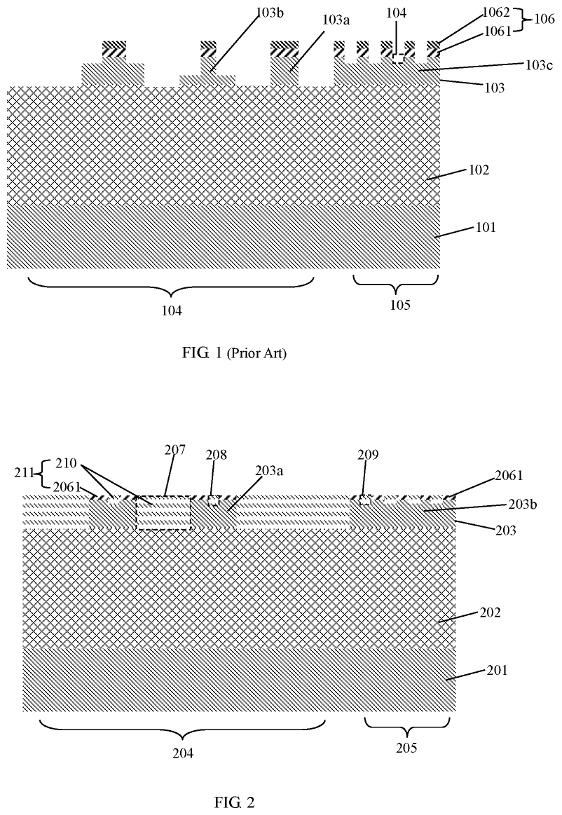

Step 1. Referring to FIG. 1, a second material layer 203 with a first dielectric layer 202 formed at the bottom thereof is provided, wherein the first dielectric layer 202 serves as a lower cladding layer of the optical waveguide structure; and a hard mask layer 206 is formed on the surface of the second material layer 203.

A refractive index of the second material layer 203 is greater than a refractive index of the first dielectric layer 202.

In the method of this embodiment of the present application, the first dielectric layer 202 and the second material layer 203 are provided by an SOI substrate.

The SOI substrate includes a bottom semiconductor substrate 201, a dielectric buried layer, and a top semiconductor layer.

The first dielectric layer 202 is composed of the dielectric buried layer. The second material layer 203 is composed of the top semiconductor layer.

In some embodiments, the material of the bottom semiconductor substrate 201 includes silicon.

The material of the dielectric buried layer includes an oxide layer.

The material of the top semiconductor layer includes silicon.

The hard mask layer 206 includes a first hard mask sublayer 2061 composed of an oxide layer and a second hard mask sublayer 2062 composed of silicon nitride.

In the method of this embodiment of the present application, the optical waveguide structure and a grating coupler are both formed on the SOI substrate. A region 204 is a formation region of the optical waveguide structure, and a region 205 is the formation region of the grating coupler.

Step 2. Referring to FIG. 3B, first patterned etching is performed, including the following:

A formation region of a core layer 203a is defined by means of photolithography.

The hard mask layer 206 and the second material layer 203 are sequentially etched to form the core layer 203a composed of the etched second material layer 203, wherein a top surface of the core layer 203a is covered with the hard mask layer 206, the hard mask layer 206 and the second material layer 203 outside the core layer 203a are both removed, the core layer 203a presents a strip structure, the strip structure of the core layer 203a has a first side face and a second side face on two sides of a width direction thereof, and the first side face and the second side face both extend along a length direction of the strip structure of the core layer 203a.

In the method of this embodiment of the present application, a plurality of core layers 203a are formed on the SOI substrate, and a region between the core layers 203a is a second trench 207.

Step 3. Referring to FIG. 3C, second patterned etching is performed, including the following:

A formation region of a first trench 208 is defined by means of photolithography, wherein the formation region of the first trench 208 is located in a top region of the core layer 203a.

The hard mask layer 206 and the second material layer 203 are sequentially etched to form the first trench 208, wherein the first trench 208 has a third side face and a fourth side face, the third side face and the fourth side face are located between the first side face and the second side face, and the third side face and the fourth side face both extend along the length direction of the strip structure of the core layer 203a.

In methods of some embodiments, the first trench 208 is located in a middle region of the core layer 203a in the width direction.

Step 4. Referring to FIG. 3D, the hard mask layer 206 is removed, and an upper cladding layer 211 is formed, wherein the upper cladding layer 211 fully fills the first trench 208, extends to the top surface of the core layer 203a outside the first trench 208, and coats the first side face and the second side face.

In the method of this embodiment of the present application, the upper cladding layer 211 also fully fills the second trench 207.

The material of the upper cladding layer 211 includes an oxide layer.

In the method of this embodiment of the present application, step 4 includes the following substeps:

Referring to FIG. 3D, a third oxide layer 210 is formed, wherein the third oxide layer 210 fully fills the first trench 208, extends to a surface outside the first trench 208, and fully fills an external region of the core layer 203a. The third oxide layer 210 also fully fills the second trench 207.

Referring to FIG. 2, a chemical mechanical polishing process is performed to remove the third oxide layer 210 on a top surface of the second hard mask sublayer 2062 and remove the second hard mask sublayer 2062, such that the remained third oxide layer 210 and the first hard mask sublayer 2061 jointly form the upper cladding layer 211.

In the method of this embodiment of the present application, a grating coupler composed of a patterned structure of the second material layer 203 is formed on the SOI substrate, and a formation process of the grating coupler is integrated with that of the optical waveguide structure, including the following:

Referring to FIG. 3B, at the same when the first patterned etching is performed in step 2, a formation region of the grating coupler is defined, that is, the first patterned etching forms a strip structure 203b of the grating coupler, and the strip structure 203b is also composed of the etched second material layer 203.

Referring to FIG. 3C, at the same when the second patterned etching is performed in step 3, the second material layer 203 in the formation region of the grating coupler is etched to form a plurality of third trenches 209, wherein a grating line is composed of the second material layer 203 between the third trenches 209. The third trenches 209 and the grating lines are alternately arranged to form the grating coupler.

The present application is described in detail above via specific embodiments, but these embodiments are not intended to limit the present application. Without departing from the principle of the present application, those skilled in the art can still make many variations and improvements, which should also be construed as falling into the protection scope of the present application.

What is claimed is:

1. An optical waveguide structure, comprising:
a lower cladding layer composed of a first dielectric layer; and
a core layer composed of a patterned structure of a second material layer, wherein the core layer presents a strip structure;
the strip structure of the core layer has a first side face and a second side face on two sides of a width direction thereof, and the first side face and the second side face both extend along a length direction of the strip structure of the core layer;
a first trench is formed in a top region of the core layer, the first trench has a third side face and a fourth side face, the third side face and the fourth side face are located between the first side face and the second side face, and the third side face and the fourth side face both extend along the length direction of the strip structure of the core layer;
an upper cladding layer fully fills the first trench, extends to a top surface of the core layer outside the first trench, and coats the first side face and the second side face; and
a refractive index of the second material layer is greater than a refractive index of the first dielectric layer, and the refractive index of the second material layer is greater than a refractive index of the upper cladding layer.

2. The optical waveguide structure according to claim 1, wherein the optical waveguide structure is formed on a semiconductor on insulation (SOI) substrate;
the SOI substrate comprises a bottom semiconductor substrate, a dielectric buried layer, and a top semiconductor layer;
the first dielectric layer is composed of the dielectric buried layer; and
the second material layer is composed of the top semiconductor layer.

3. The optical waveguide structure according to claim 2, wherein a material of the bottom semiconductor substrate comprises silicon;
a material of the dielectric buried layer comprises an oxide layer; and
a material of the top semiconductor layer comprises silicon.

4. The optical waveguide structure according to claim 3, wherein a material of the upper cladding layer comprises an oxide layer.

5. The optical waveguide structure according to claim 2, wherein a plurality of core layers are formed on the SOI substrate, a region between the core layers is a second trench, and the upper cladding layer fully fills the second trench.

6. The optical waveguide structure according to claim 2, wherein a grating coupler is formed on the SOI substrate, and the grating coupler is composed of the patterned structure of the second material layer and comprises a plurality of third trenches formed by etching the second material layer and a plurality of grating lines each located between the third trenches and composed of the second material layer.

7. The optical waveguide structure according to claim 6, wherein a process structure of the first trench is the same as that of the third trenches.

8. The optical waveguide structure according to claim 1, wherein the first trench is located in a middle region of the core layer in the width direction.

9. A method for manufacturing an optical waveguide structure, comprising the following steps:
step 1, providing a second material layer with a first dielectric layer formed at a bottom thereof, wherein the first dielectric layer serves as a lower cladding layer of the optical waveguide structure, and forming a hard mask layer on a surface of the second material layer, wherein a refractive index of the second material layer is greater than a refractive index of the first dielectric layer;
step 2, performing first patterned etching, comprising:
defining a formation region of a core layer by means of photolithography; and
sequentially etching the hard mask layer and the second material layer to form the core layer composed of the etched second material layer, wherein a top surface of the core layer is covered with the hard mask layer, the hard mask layer and the second material layer outside the core layer are both removed, the core layer presents a strip structure, the strip structure of the core layer has a first side face and a second side face on two sides of a width direction thereof, and the first side face and the second side face both extend along a length direction of the strip structure of the core layer;
step 3, performing second patterned etching, comprising:
defining a formation region of a first trench by means of photolithography, wherein the formation region of the first trench is located in a top region of the core layer; and
sequentially etching the hard mask layer and the second material layer to form the first trench, wherein the first trench has a third side face and a fourth side face, the third side face and the fourth side face are located between the first side face and the second side face, and the third side face and the fourth side face both extend along the length direction of the strip structure of the core layer; and
step 4, removing the hard mask layer, and forming an upper cladding layer, wherein the upper cladding layer fully fills the first trench, extends to the top surface of the core layer outside the first trench, and coats the first side face and the second side face.

10. The method for manufacturing the optical waveguide structure according to claim 9, wherein the first dielectric layer and the second material layer are provided by a semiconductor on insulation (SOI) substrate in step 1;
the SOI substrate comprises a bottom semiconductor substrate, a dielectric buried layer, and a top semiconductor layer;
the first dielectric layer is composed of the dielectric buried layer; and
the second material layer is composed of the top semiconductor layer.

11. The method for manufacturing the optical waveguide structure according to claim 10, wherein a material of the bottom semiconductor substrate comprises silicon;
a material of the dielectric buried layer comprises an oxide layer; and
a material of the top semiconductor layer comprises silicon.

12. The method for manufacturing the optical waveguide structure according to claim 11, wherein a material of the upper cladding layer comprises an oxide layer.

13. The method for manufacturing the optical waveguide structure according to claim 12, wherein the hard mask layer comprises a first hard mask sublayer composed of an oxide layer and a second hard mask sublayer composed of silicon nitride.

14. The method for manufacturing the optical waveguide structure according to claim 13, wherein step 4 comprises the following sub steps:
forming a third oxide layer, wherein the third oxide layer fully fills the first trench, extends to a surface outside the first trench, and fully fills an external region of the core layer; and
performing a chemical mechanical polishing process to remove the third oxide layer on a top surface of the second hard mask sublayer and remove the second hard mask sublayer, such that a remained third oxide layer and the first hard mask sublayer jointly form the upper cladding layer.

15. The method for manufacturing the optical waveguide structure according to claim 10, wherein a plurality of core layers are formed on the SOI substrate, a region between the core layers is a second trench, and the upper cladding layer fully fills the second trench.

16. The method for manufacturing the optical waveguide structure according to claim 10, wherein a grating coupler composed of a patterned structure of the second material layer is formed on the SOI substrate, and a formation process of the grating coupler is integrated with that of the optical waveguide structure, comprising:
at a same time when the first patterned etching is performed in step 2, defining a formation region of the grating coupler; and
at a same time when the second patterned etching is performed in step 3, etching the second material layer in the formation region of the grating coupler to form a plurality of third trenches, wherein a grating line is composed of the second material layer between the third trenches.

17. The method for manufacturing the optical waveguide structure according to claim 9, wherein the first trench is located in a middle region of the core layer in the width direction.
